(19) United States
(12) Patent Application Publication
(10) Pub. No.: US 2025/0005149 A1
(43) Pub. Date: Jan. 2, 2025

(54) Federated Privacy-Preserving Nearest-Neighbor Search (NNS)-Based Label Propagation on Shared Embedding Space

(71) Applicant: Google LLC, Mountain View, CA (US)

(72) Inventors: Animesh Nandi, Cupertino, CA (US); Alessandro Epasto, New York, NY (US)

(21) Appl. No.: 18/343,132

(22) Filed: Jun. 28, 2023

(51) Int. Cl. G06F 21/56

(52) U.S. Cl. CPC G06F 21/56

(57) ABSTRACT

For a plurality of iterations, entity detection information is obtained from one or more client computing devices. The entity detection information includes (a) information that indicates whether an entity detected at the client computing device is malicious, and (b) information that associates the entity with a particular subspace of a plurality of subspaces of an embedding space. The entity detection information received over the plurality of iterations is aggregated to obtain aggregated threat information, wherein the aggregated threat information is descriptive of a number of malicious entities and a total number of entities detected for each subspace of the plurality of subspaces. Based on the entity detection information subspace classification information is generated that identifies a first subspace of the plurality of subspaces as being a malicious subspace associated with malicious entities.

### FIELD

The present disclosure relates generally to detecting and identifying whether entities are malicious. More specifically, the present disclosure relates to optimizing a shared embedding space for detecting malicious entities in a federated, privacy-preserving manner.

### BACKGROUND

Cybersecurity is the process by which organizations safeguard networks, systems, and sensitive information against malicious entities. Accurate detection and identification of malicious entities is critical to providing effective cybersecurity. A “malicious entity” generally refers to an actor, such as a human or an automated bot program, that engages in malicious behavior with the purpose of gaining access to users, information, and/or systems. The likelihood of a malicious entity gaining such access is substantially reduced once the malicious entity has been accurately detected and identified. As such, malicious entities frequently innovate new techniques to obscure their identity and behavior.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes, for a plurality of iterations, obtaining, by a computing system comprising one or more processor devices, entity detection information from one or more client computing devices, wherein the entity detection information comprises (a) information that indicates whether an entity detected at the client computing device is malicious; and (b) information that associates the entity with a particular subspace of a plurality of subspaces of an embedding space. The method includes aggregating, by the computing system, the entity detection information received over the plurality of iterations to obtain aggregated threat information, wherein the aggregated threat information is descriptive of a number of malicious entities and a total number of entities detected for each subspace of the plurality of subspaces. The method includes, based on the entity detection information, generating, by the computing system, subspace classification information that identifies a first subspace of the plurality of subspaces as being a malicious subspace associated with malicious entities.

Another example aspect of the present disclosure is directed to client computing device, comprising one or more processors and one or more non-transitory computer-readable media that collectively store a first set of instructions that, when executed by the one or more processors, cause the client computing device to perform operations. The operations include, for one or more iterations, detecting an entity. The operations include determining whether the entity is malicious. The operations include using a plurality of randomized vectors to determine an identifying code for the entity, wherein the plurality of randomized vectors are for performing a Locality Sensitive Hashing (LSH) process that partitions an embedding space of a computing system into a plurality of subspaces with a structure that is unknown to the client computing device, and wherein the identifying code is one of a plurality of identifying codes respectively associated with the plurality of subspaces. The operations include providing entity detection information, wherein the entity detection information comprises (a) information that indicates whether the entity is malicious; and (b) information indicative of the identifying code for the entity.

Another example aspect of the present disclosure is directed to cybersecurity computing system including one or more processors and a memory. The memory includes an embedding space, wherein the embedding space is partitioned into a plurality of subspaces based on a plurality of randomized vectors. The memory includes one or more non-transitory computer-readable media that collectively store a first set of instructions that, when executed by the one or more processors, cause the cybersecurity computing system to perform operations. The operations include receiving an entity identification request from a client computing device that comprises an identifying code, wherein (a) the identifying code is determined based on the plurality of randomized vectors for an entity detected locally at the client computing device, and (b) the identifying code is one of a plurality of identifying codes respectively associated with a plurality of subspaces of an embedding space. The operations include determining that the subspace associated with the identifying code is a malicious subspace associated with malicious entities. The operations include providing information to the client computing device indicating that the entity is a malicious entity.

Another example aspect of the present disclosure is directed to a client computing device including one or more processors and a memory. The memory includes a machine-learned embedding model, wherein the machine-learned embedding model is trained to process information associated with an entity to generate an embedding for the entity. The memory includes one or more non-transitory computer-readable media that collectively store a first set of instructions that, when executed by the one or more processors, cause the client computing device to perform operations. The operations include detecting an entity. The operations include processing information associated with the entity with the machine-learned embedding model to generate an entity embedding. The operations include, based on a plurality of randomized vectors and the entity embedding, determining an identifying code for the entity, wherein the identifying code is one of a plurality of identifying codes respectively associated with a plurality of subspaces of an embedding space implemented by a computing system, and wherein the plurality of randomized vectors are the same vectors used to partition the embedding space into the plurality of subspaces. The operations include providing, to the computing system, an entity identification request comprising the identifying code. The operations include, responsive to providing the entity identification request, receiving, from the computing system, information indicating that the entity is malicious.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 is an overview block diagram for a computing environment that optimizes a shared embedding space in a federated privacy-preserving manner according to some implementations of the present disclosure.

FIG. 2A is a flow diagram of an example method for privacy-preserving federated optimization of a shared embedding space for detection of malicious entities, in accordance with some embodiments of the present disclosure.

FIG. 2B is a flow diagram of an example method for providing identifying codes known to be associated with malicious actors to client computing devices, in accordance with some embodiments of the present disclosure.

FIG. 3 illustrates an example hierarchical subspace structure of an embedding space according to some implementations of the present disclosure.

FIG. 4 is a block diagram of an example computing system that optimizes a shared embedding space for detection of malicious entities according to some implementations of the present disclosure.

FIG. 5 is a flow diagram of an example method for populating a shared embedding space for detection of malicious entities in a federated, privacy-preserving manner, in accordance with some embodiments of the present disclosure.

FIG. 6 is a flow diagram of an example method for requesting identification of an entity from a computing system that implements an embedding space that has been populated in a federated, privacy-preserving manner, in accordance with some implementations of the present disclosure.

FIG. 7 is a block diagram of an example client computing device that populates a shared embedding space for detection of malicious entities according to some implementations of the present disclosure.

FIG. 8 depicts a block diagram of an example computing environment suitable for implementing examples according to some implementations of the present disclosure.

Reference numerals that are repeated across plural figures are intended to identify the same features in various implementations.

### DETAILED DESCRIPTION

Generally, the present disclosure is directed to detecting and identifying whether entities are malicious. More specifically, the present disclosure relates to optimizing a shared embedding space for detecting malicious entities (e.g., “spammy” entities, actors controlling malicious or spammy entities, etc.) in a federated, privacy-preserving manner. Recent cybersecurity approaches have leveraged advancements in the field of machine learning to counter these techniques. Specifically, some approaches have used machine-learned embedding models to generate embeddings for an embedding space to determine whether an entity is malicious. An embedding, which is generated as an output of an embedding model, generally refers to an intermediate representation (e.g., a vector, etc.) of the information that is input to the embedding model. An embedding space refers to a multidimensional space in which embeddings are positioned. Within an embedding space, the “distance” between embeddings is generally correlated to the degree of similarity between embeddings. In other words, the higher the similarity between two entities with regards to underlying features, the smaller is the ‘distance’ between those entities in the embedding space. By performing what is known as a “nearest neighbor” search, an unknown entity can be classified based on the distance between its embedding and other known embeddings in the embedding space. For example, if an embedding for an unknown entity is located close to an embedding for a known malicious entity, it is relatively likely that the unknown entity is malicious.

An embedding space, once populated, can be utilized to accurately detect and identify unknown entities. Conventionally, this can be accomplished by a computing system that maintains and utilizes the embedding space to determine whether an entity detected locally by a client computing device is malicious. For example, if a client computing device (e.g., a user device, a compute node in a network that is separate from the computing system, etc.) receives an email, and is unsure whether the email is malicious, the client computing device can send the email and any associated information (e.g., a sender IP address, etc.) to the computing system. The computing system can generate an embedding from the information and perform a nearest neighbor search to determine whether the entity is malicious based on the embedding's proximity to embeddings of known malicious entities in the embedding space.

However, such an approach requires the centralized collection of sensitive user information, which is incompatible with many data privacy regulations and policies. Furthermore, cybersecurity systems have recently trended towards end-to-end encryption of all communications, and end-to-end encrypted communications cannot be read by the computing system. To overcome these deficiencies, some techniques have attempted to generate embeddings locally and then transmit the embeddings to the computing system. However, this creates substantial security vulnerabilities due to the possibility of embeddings being reverse engineered. Other techniques have attempted localized training and establishment of embedding spaces on client computing devices so that communication with the computing system is unnecessary. However, such approaches generally exhibit poor performance.

Accordingly, implementations of the present disclosure propose a privacy-preserving federated approach to optimizing, or discretizing, a shared embedding space. More specifically, a computing system can establish an embedding space, and partition the embedding space into multiple subspaces. Client computing devices (e.g., user devices, virtualized computing devices, etc.) served by the computing system will locally detect entities over time. Upon detection of an entity, a client computing device can (a) determine whether the entity is malicious, and (b) determine which subspace the entity belongs to. The client computing devices can send this information to the computing system.

As the computing system receives information from the client computing devices, the computing system can aggregate the information to identify certain subspaces of the embedding space as being associated with a high density of malicious entities, otherwise known as “malicious subspaces.” Once established, if a client computing device is unsure whether a detected entity is malicious, the client computing device can query the computing system by providing an identifier for the subspace. The computing system can respond by simply indicating whether the subspace is a malicious subspace. In such fashion, the client computing device can communicate with the computing system to determine whether an entity is malicious while preserving user privacy and eliminating the possibility of malicious actors intercepting and reverse-engineering sensitive information.

Aspects of the present disclosure provide a number of technical effects and benefits. As one example technical effect and benefit, many embedding space approaches to threat detection are centralized, and therefore centralize sensitive user information in a manner that is incompatible with most data privacy regulations. However, the proposed privacy preserving approach to federated analysis using a discretized, shared embedding space described herein is compliant with some of the most stringent data regulations. Additionally, implementations of the present disclosure eliminate multiple attack vectors used by malicious entities to steal sensitive user information (e.g., intercepting embeddings, etc.), thus substantially increasing user data security.

With reference now to the Figures, example implementations of the present disclosure will be discussed in further detail.

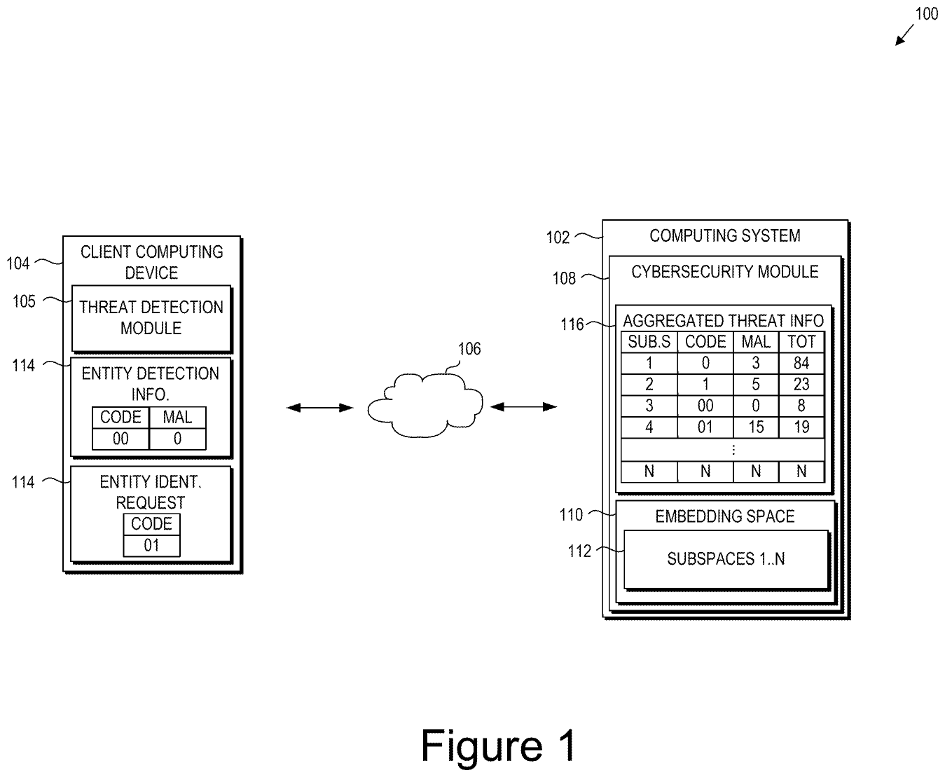

FIG. 1 is an overview block diagram for a computing environment 100 that optimizes a shared embedding space in a federated privacy-preserving manner according to some implementations of the present disclosure. The computing environment 100 can include a computing system 102 and a client computing device 104. The computing system 102 can be any type or manner of computing system (e.g., a compute node, a virtualized system, a cloud-based system, etc.) that provides cybersecurity services or functions within the computing environment 100. For example, the computing system 102 can identify malicious entities that are detected locally by the client computing device 104.

An entity, as described herein, generally refers to a specific actor (e.g., a human, an automated program, etc.), information sent by an actor (e.g., an email, code package, communication information, etc.), action(s) taken by actor(s), and/or the behavior patterns of actor(s) (e.g., behavioral information). Examples of entities include specific machines, multiple requests from actor(s) that collectively form a Distributed Denial of Service (DDOS) attack, spam and/or phishing emails, wireless communications, data packets, login patterns across multiple accounts controlled by the same actor, executables, websites, etc.

Entities can be detected locally by client computing devices, such as the client computing device 104. Local detection and identification of entities is especially common in privacy-preserving computing environments that encrypt data transmission end-to-end because these transmissions cannot be analyzed by other computing systems of the computing environment 100. For example, assume that the entity is an end-to-end encrypted email. The client computing device 104 can “detect” the entity upon decryption of the email locally at the client computing device. The client computing device 104 can attempt to identify whether the entity is a malicious entity using threat detection module 105. If the client computing device 104 is unable to locally identify whether the entity is malicious, the client computing device 104 can request that the computing system 102 identify whether the entity is malicious. For example, the client computing device 104 can transmit such a request to the computing system 102 via network(s) 106. Network(s) 106 can be any type of wired and/or wireless network(s) sufficient to convey information between the client computing device 104 and the computing system 102.

The computing system 102 can include a cybersecurity module 108. The cybersecurity module 108 can identify whether an entity is malicious in a federated, privacy-preserving manner. To do so, the cybersecurity module 108 can instantiate an embedding space 110. The cybersecurity module 108 can partition the embedding space 110 into subspaces 112. The cybersecurity module 108 can determine an identifying code for each of the subspaces 112. For example, the cybersecurity module 108 can perform Locality Sensitive Hashing (LSH) process to partition the embedding space 110 based on a set of randomized vectors. LSH processes, such as LSH-Forest, can utilize randomized vectors as random hyperplanes to partition the embedding space. Hash codes can be established for each partitioned subspace of the embedding space during the LSH process. The cybersecurity module 108 can utilize the hash codes established during the LSH process as identifying codes for the subspaces 112.

The embedding space 110 can be populated before it is utilized to identify malicious entities. To populate the embedding space 110, the client computing device 104 can provide entity detection information 114 to the computing system 102. Entity detection information 114 can be generated when an entity is locally detected and identified by the client computing device 104. The entity detection information 114 can include (a) information that indicates whether an entity is malicious, and (b) information that associates the entity with a particular subspace of the subspaces 112.

For example, the threat detection module 105 can detect an email entity using the threat detection module 105. The threat detection module 105 can identify that the entity is a malicious entity (e.g., a spam email, etc.). The threat detection module 105 can generate the entity detection information 114. The entity detection information can include information that indicates whether the entity is malicious (e.g., a value of 0 for a non-malicious entity, a value of 1 for a malicious entity, etc.). The entity detection information 114 can also include information that associates the entity with a particular subspace of the subspaces 112, such as an identifying code for a subspace (e.g., code 00).

The client computing device 104 can generate and provide entity detection information 114 to the computing system 102 for each entity detected and identified locally at the client computing device 104. The cybersecurity module 108 can aggregate the entity detection information 114 received from the client computing device 104 as aggregated threat information 116. The aggregated threat information 116 can track a total number of entities and a total number of malicious entities detected for each of the subspaces 112. To follow the depicted example, the aggregated threat information 116 can indicate that 3 malicious entities, and 84 total entities, have been detected and associated with the subspace with identifying code “0”.

Based on the aggregated threat information 116, the cybersecurity module 108 can identify certain subspaces of the subspaces 112 as being “malicious subspaces” that are associated with malicious entities. To follow the depicted example, the ratio of malicious entities to non-malicious entities is relatively low for the entities associated with the subspace identified by identifying code “0” (e.g., 3 of 84 total). As such, the cybersecurity module 108 can refrain from identifying that subspace as being a malicious subspace, and/or can identify that particular subspace as being a “non-malicious” subspace (e.g., a subspace associated with non-malicious entities). The ratio of malicious entities to non-malicious entities is relatively high for the entities associated with the subspace identified by identifying code “01” (e.g., 15 of 19 total). As such, the cybersecurity module 108 can identify that particular subspace as being a malicious subspace associated with malicious entities.

The computing system 102 can leverage the embedding space 110 to identify malicious entities for the client computing device 104 in a federated, privacy-preserving manner. For example, assume that the threat detection module 105 detects an entity, but fails to identify whether the entity is malicious. The threat detection module 105 can generate an entity identification request 118 and provide the entity identification request 118 to the computing system 102. The entity identification request 118 can include information that associates the entity with a particular subspace of the subspaces 112, such as an identifying code. If the identifying code is associated with a malicious subspace, the computing system 102 can provide information to the client computing device 104 indicating that the entity is malicious. If the identifying code is associated with a non-malicious subspace, the computing system 102 can provide information to the client computing device 104 indicating that the entity is not malicious.

In such fashion, the computing system 102 can identify whether entities detected locally at the client computing device 104 are malicious or non-malicious in a federated, privacy-preserving manner. In particular, rather than directly transmitting information associated with the entity to the computing system, the client computing device 104 can instead provide only the identifying code for the entity. By obviating the need to transmit private information to the computing system 102, implementations of the present disclosure can identify malicious entities while preserving user privacy.

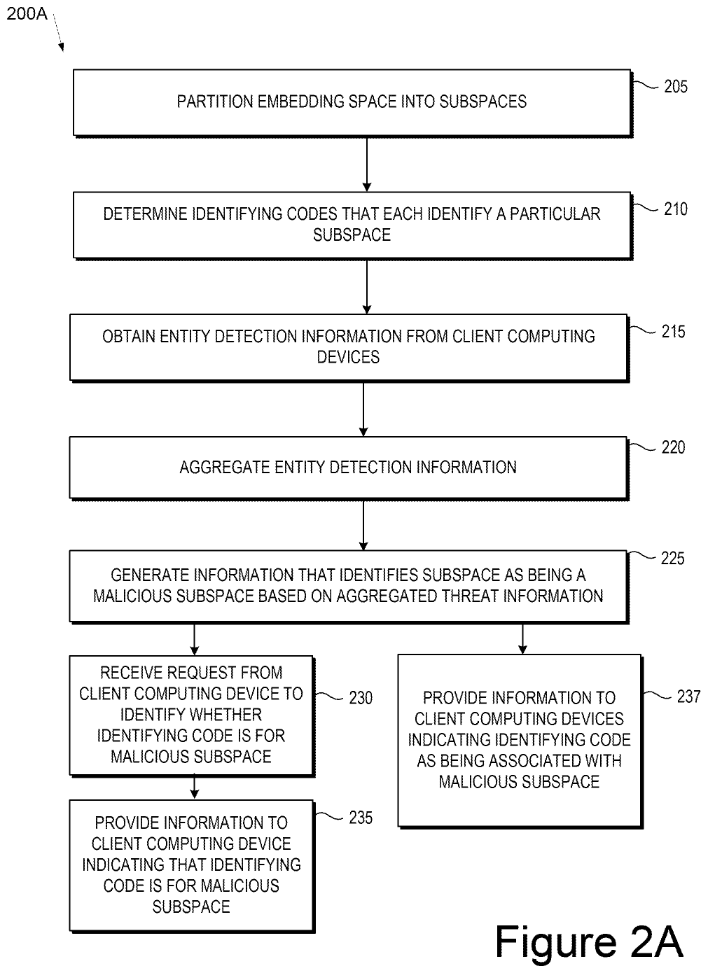

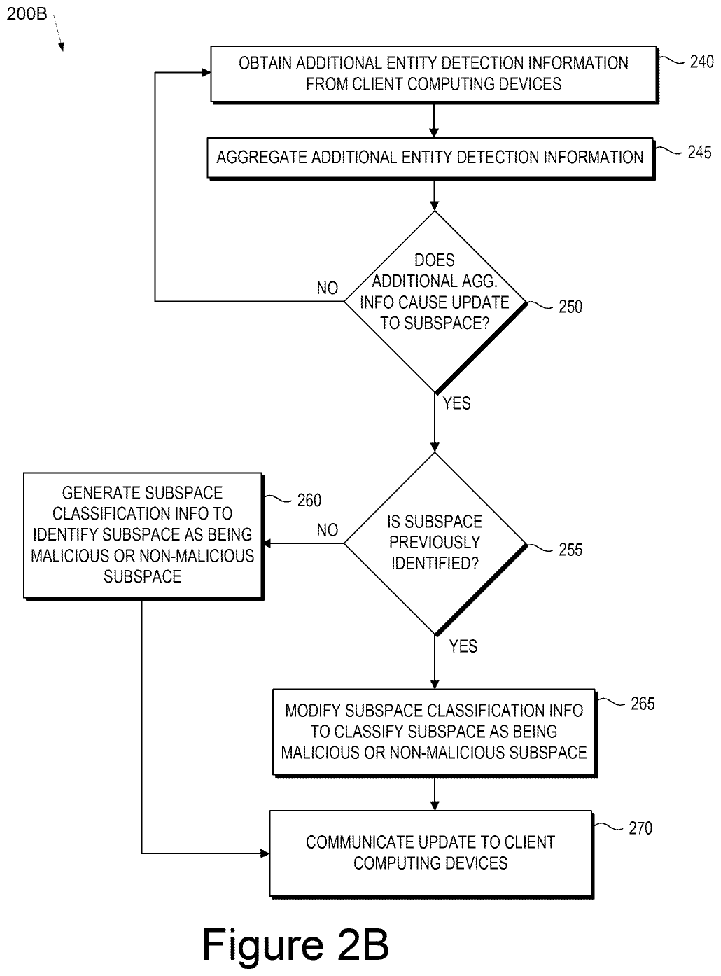

FIG. 2A is a flow diagram of an example method 200A for privacy-preserving federated optimization of a shared embedding space for detection of malicious entities, in accordance with some implementations of the present disclosure. The method 200A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the cybersecurity module 108 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 205, processing logic can partition an embedding space into subspaces. An “embedding space” refers to a lower-dimensional space to which “embeddings” can be mapped. An embedding is a low-dimensional, learned representation of a higher-dimensional input (i.e., ML-Features). For example, a machine-learned embedding model can be trained to generate embeddings for a particular type of input, such as an email. Once trained, the model can process an email input to generate an embedding, such as a vector, that serves as a lower-dimensional representation of the email. The embedding can be mapped to a particular “location” in the embedding space. In some instances, the mapped location of the embedding can be located within a particular “portion,” or “region” of the embedding space to which other embeddings are mapped.

Generally, the distance between the mapped locations of embeddings within an embedding space is indicative of a similarity (or lack thereof) between the inputs represented by the embeddings. For example, assume that the machine-learned embedding model processes a newly received email to generate an embedding of the email. The email embedding is mapped to a portion of the embedding space that is shared by a cluster of embeddings that represent previously received emails. If the previously received emails are known to be non-malicious, it can be inferred that the newly received email is likely to be non-malicious. If the previously received emails are known to be malicious, it can be inferred that the newly received email is likely to be malicious.

In such fashion, an embedding space that is populated with embeddings for entities with known classifications can be utilized to predict a classification for a new entity. To more accurately predict classifications for new embeddings, an embedding space can be partitioned into discrete subspaces. Specifically, once partitioned, information associated with entities can be aggregated on a per-subspace basis as the embeddings for the entities are mapped to specific subspaces.

For example, assume that embeddings for fifteen entities are mapped to a third subspace of an embedding space, and that thirteen of the fifteen entities are known to be malicious. Because the percentage of malicious entities mapped to the third subspace is relatively high at 87%, a computing system may classify the third subspace as a “malicious” subspace. With this classification, the computing system can assume that future embeddings mapped to the third subspace represent malicious entities. If only two of the fifteen entities were known to be malicious, the computing system can instead classify the third subspace as a “non-malicious” subspace.

In some implementations, the embedding space can be partitioned using a Locality-Sensitive Hashing (LSH) process. An LSH process utilizes hyperplanes to partition an embedding space into subspaces. An LSH process utilizes randomized vectors as hyperplanes to partition an embedding space into subspaces. In particular, LSH processes enable client devices to locally determine subspaces for embeddings while only having access to metadata, such as RNG seeds, or the randomized vectors.

Some LSH processes, such as LSH-Forest, partition embedding spaces in a recursive and/or hierarchical manner. For example, LSH-Forest can utilize random hyperplanes to partition an embedding space into subspaces in a hierarchical, tree-like structure. A random hyperplane refers to a vector that includes a number of randomized values that corresponds to the number of dimensions of the embedding space. At each point in the structure, a random hyperplane can “divide” the embedding space, or subspace of the embedding space, into two subspaces. The randomized hyperplane can be generated using Random Number Generation (RNG) seeds, which can be obtained from a variety of sources (e.g., quantum “true” RNG services, random noise from hardware devices, etc.).

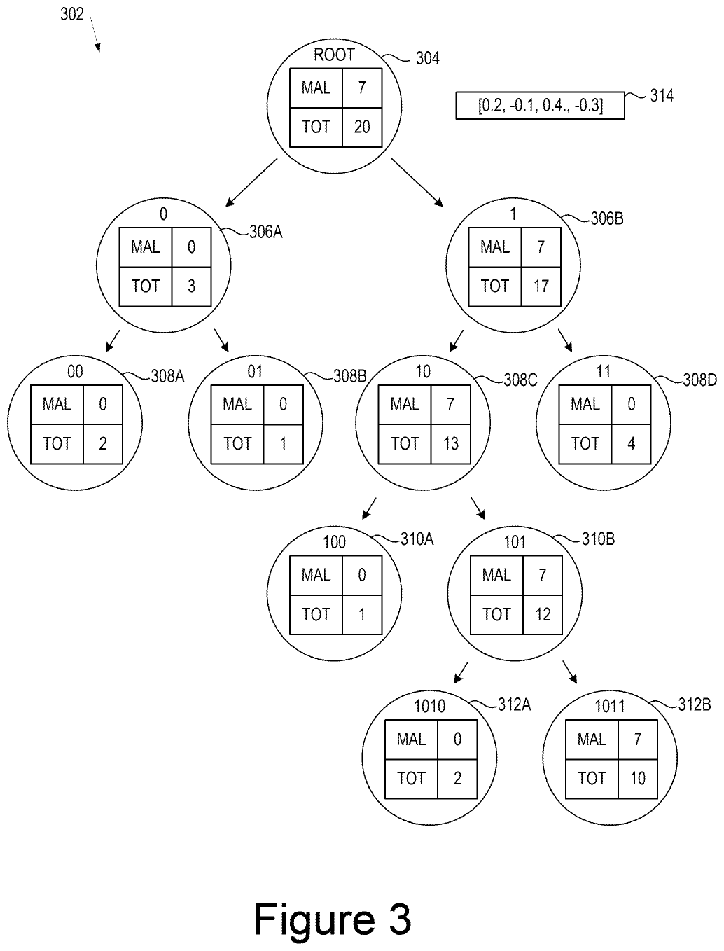

As a particular example, turning to FIG. 3, FIG. 3 illustrates an example hierarchical subspace structure 302 of an embedding space according to some implementations of the present disclosure. The hierarchical subspace structure 302 is a tree-like structure generated using an LSH process, such as LSH-Forest, in which subspaces of the embedding space are organized hierarchically. The hierarchical subspace structure 302 starts with a “root” space 304, which is divided into two subspaces 306A and 306B using a random hyperplane. Subspace 306A is further divided with another random hyperplane into subspaces 308A and 308B. Similarly, subspace 306B is further divided into subspaces 308C and 308D. Subspace 308C is divided into subspaces 310A and 310B, which is divided to subspaces 312A and 312B.

To insert embeddings into the hierarchical subspace structure 302, a dot product multiplication operation can be performed at each subspace. For example, assume that embedding 314 is a recently generated embedding for an entity with a known classification. A dot product multiplication can be performed between the embedding 314 and the random hyperplane associated with the space 304 (e.g., the random hyperplane utilized to partition the space 304 into subspaces 306A and 306B). If the sign of the result is negative, the embedding 314 can descend to subspace 306A where another dot product multiplication can be performed between the embedding 314 and the random hyperplane associated with the subspace 306A (e.g., the random hyperplane utilized to partition the subspace 306A into subspaces 308A and 308B). If the sign of the result is positive, the embedding 314 can descend to subspace 306B. In such fashion, the embedding 314 can descend the hierarchical subspace structure 302 until mapped to one of the subspaces. For example, a hierarchical subspace structure with a depth of N would be partitioned using N hyperplanes. To descend to the lowest level, the dot product multiplication would be successively performed between the embedding and the N hyperplanes.

Because each subsequent subspace of the hierarchical subspace structure 302 is partitioned from a preceding subspace, the “lowest” subspaces in the structure, such as subspaces 312A and 312B, will generally be more precise than preceding subspaces, such as space 304. In some implementations, the preciseness of a particular subspace can be accounted for when identifying the subspace as being a malicious subspace.

Returning to FIG. 2A, at operation 210, the processing logic can determine identifying codes. Each identifying code can be a code that is associated with and identifies a specific subspace. In particular, the identifying codes can be determined in accordance with the process utilized to partition the embedding space. In some implementations, the LSH-Forest process can be utilized to both partition the embedding space and to determine identifying codes for the subspaces of the embedding space.

For example, turning to FIG. 3, assume that the hierarchical subspace structure 302 is determined using the LSH-Forest process. In addition to determining the hierarchical subspace structure 302, the LSH-Forest process can also be utilized to assign identifying codes, such as prefix-codes, to each subspace. Identifying codes such as prefix-codes can increase in length as subspaces are partitioned further. To follow the depicted example, subspace 308C has an identifying code of “10.” Subspaces 310A and 310B, which are partitioned from subspace 308C, can have identifying codes of “100” and “101” respectively. Subspaces 312A and 312B, which are partitioned from subspace 310B, can have identifying codes of “1010” and “1011,” respectively.

Returning to FIG. 2A, the identifying codes determined by the processing logic are codes that can be determined locally by client devices for embeddings generated for entities detected at the client devices. For example, assume that a computing system utilizes the LSH-Forest process to partition an embedding space into subspaces, and to determine identifying codes for the subspaces using random hyperplanes generated based on RNG seeds. If the computing system does not inform client devices, the client devices will be unaware of the identifying codes assigned to the subspaces.

However, LSH-Forest enables client devices to use the same random hyperplanes to locally determine identifying codes for embeddings without prior knowledge of the embedding space and the manner in which it is partitioned. In other words, client devices can utilize the same random hyperplanes used to partition the embedding space to locally, and accurately, assign an identifying code to an embedding without prior knowledge of the identifying codes and their association to particular subspaces.

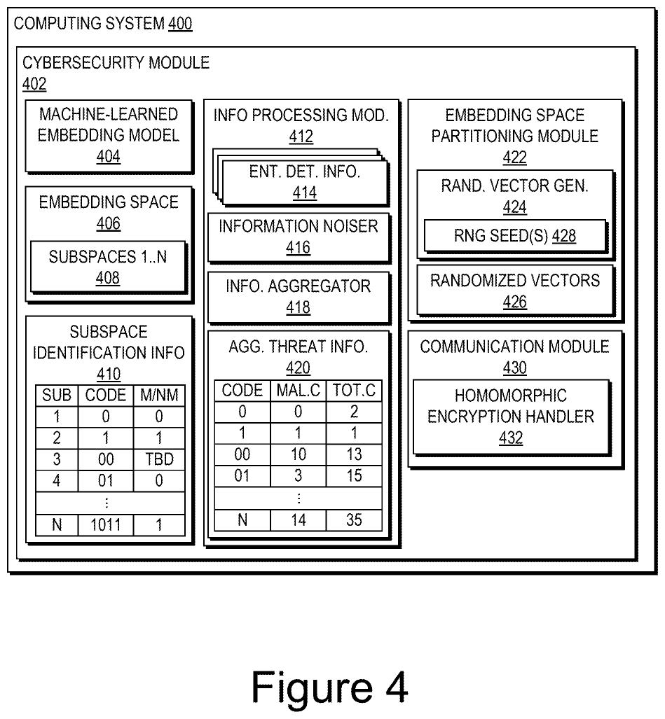

In some implementations, the random hyperplanes (e.g., vectors of randomized values) can be directly provided to client computing devices. Alternatively, in some implementations, information descriptive of the random hyperplanes can be provided to the client computing devices so that the random hyperplanes can be generated locally at the client computing device. For example, the RNG seeds used to generate the random hyperplanes can be provided to the client computing devices. In such fashion, random hyperplanes can be provided to the client computing devices locally while avoiding potential security vulnerabilities associated with direct transmission of the random hyperplanes. Local determination of identifying codes will be discussed in greater detail with regards to FIG. 4.

At operation 215, the processing logic can obtain entity detection information from client computing devices. Entity detection information can include information that indicates whether an entity detected at a client computing device is malicious. For example, assume that a client computing device “detects” an email entity upon receipt of an end-to-end encrypted email. The client computing device can decrypt the email and utilize various local cybersecurity processes to identify the email as malicious (e.g., a lightweight machine-learned spam detection model, etc.). The entity detection information provided by the client computing device can include information indicating that the detected email is malicious.

The entity detection information can also include information that associates the entity with a particular subspace of the embedding space. For example, as described previously, the client computing device can receive information sufficient to obtain the random hyperplanes used to partition the embedding space. The client computing device can utilize the random hyperplanes to determine an identifying code for the entity (e.g., an embedding subspace code), and the entity detection information can include the determined identifying code. The identifying code determined by the computing system can be associated with a particular subspace of the embedding space.

At operation 220, the processing logic can, over a number of iterations, aggregate entity detection information received from various client computing devices to obtain aggregated threat information. For each subspace of the embedding space, the aggregated threat information can include a number of malicious entities associated with the subspace and a total number of entities associated with the embedding space. For example, turning to FIG. 3, assume that entity detection information for 4 detected entities is received from client computing devices. The entity detection information can indicate that each of the 4 entities are associated with the subspace 308D, and can indicate that the 4 entities are each non-malicious. The entity detection information can be aggregated to obtain aggregated threat information. The aggregated threat information can indicate that 0 malicious entities are associated with the subspace 308D, and that 4 total entities are associated with the subspace 308D.

For another example, assume that entity detection information for 19 entities is received from client computing devices. The entity detection information can indicate that each of the 19 entities are associated with the subspace 310B (e.g., via identifying code “101”, etc.), and can indicate that 7 of the 19 entities are malicious. The entity detection information can be aggregated to obtain the aggregated threat information. The aggregated threat information can indicate that 7 malicious entities are associated with the subspace 310B, and that 19 total entities are associated with the subspace 310B.

In some implementations, prior to aggregating the threat information, the processing logic can mix at least some of the entity detection information to obtain mixed entity detection information. The processing logic can add noise to the mixed entity detection information. As used herein, “noise” generally refers to randomizing portions of information to reduce the likelihood of reverse engineering by malicious entities. For example, assume that the entity detection information indicates whether an entity is malicious with a binary value (e.g., “0” for non-malicious and “1” for malicious). The processing logic can add noise to the mixed entity detection information by changing the binary value for every tenth entity.

Returning to FIG. 2A, at operation 225, the processing logic can generate information that identifies a particular subspace as being a malicious subspace. A malicious subspace refers to a subspace “known” to be associated with malicious entities. In other words, a subspace identified as being a malicious subspace indicates a high probability that entities associated with the subspace are malicious. A subspace can be identified as being a “malicious” subspace based on the quantity, and/or percentage, of malicious entities associated with the subspace. The information that identifies a subspace as being a malicious subspace can be generated and/or stored in any type or manner of data structure or database. For example, the information can be, or otherwise include, an attribute applied to information associated with the subspace in a relational database.

To follow the previous examples, subspace 308D is associated with 0 malicious entities and 4 total entities. Because there are no malicious entities associated with the subspace 308D, the subspace 308D is unlikely to be identified as being a malicious subspace. Subspace 310B, however, is associated with 7 malicious entities and 12 total entities. In other words, 58% of the entities associated with the subspace 310B are malicious. In this instance, the subspace 310B may or may not be identified as being a malicious subspace.

In some implementations, identification of a subspace as being a malicious subspace can be based on subspace security parameters. The subspace security parameters can include threshold values that must be satisfied to identify a subspace as being a malicious subspace. For example, the subspace security parameters can indicate that a subspace can be identified as being a malicious subspace if 70% or more of the entities associated with the subspace are malicious. For another example, the subspace security parameters can indicate that a subspace can be identified as being a malicious subspace if 85% or more of the entities associated with the subspace are malicious and there are greater than 25 entities associated with the subspace. In some implementations, the subspace security parameters can vary based on the hierarchical positioning of the subspace within the embedding space. For example, the subspace security parameters can indicate that subspace 310B requires fewer associated entities than subspace 308D to be identified as being a malicious subspace because subspace 310B is a more “precise” subspace.

In some implementations, the values for the subspace security parameters can be controlled by users. Additionally, or alternatively, in some implementations, the values for the subspace security parameters can be automatically adjusted based on a desired degree of cybersecurity. For example, if a system is determined to contain relatively low-risk information, a relatively low level of security can be assigned to the system. Based on the low level of security, values for subspace security parameters can be adjusted (e.g., from a 70% malicious entity threshold to a 90% malicious entity threshold, etc.). If highly sensitive information is transmitted to the system, and the level of security is raised accordingly, the values for the subspace security parameters can be re-adjusted (e.g., e.g., from a 70% malicious entity threshold to a 30% malicious entity threshold, etc.).

Additionally, or alternatively, in some implementations, the processing logic can generate information that identifies a particular subspace as being a non-malicious subspace. A non-malicious subspace refers to a subspace “known” to be associated with non-malicious entities. In other words, a subspace identified as being a non-malicious subspace indicates a high probability that entities associated with the subspace are non-malicious. As described previously with regards to malicious subspaces, identification of a subspace as being a non-malicious subspace can be based on subspace security parameters. It should be noted that a subspace that is not identified as being a malicious subspace is not necessarily identified as being a non-malicious subspace (and vice-versa). Rather, for some subspaces, the aggregated threat information may be insufficient to identify the subspaces as being either malicious or non-malicious.

At operation 230, the processing logic can receive a request from a client computing device to identify whether an identifying code is for a malicious subspace. For example, assume that information has been generated that identifies a subspace as being a malicious subspace based on the aggregated threat information. Further assume that a client computing device has locally detected an entity and has failed to determine whether the entity is malicious. To determine whether the entity is malicious, the client computing device can locally determine an identifying code for the entity as described previously. The client computing device can provide a request to identify whether the identifying code for the entity is associated with a malicious subspace.

At operation 235, upon receipt of the request, the processing logic can determine that the identifying code is associated with a subspace identified as being a malicious subspace. The processing logic can provide information to the client computing device indicating that the identifying code is associated with a malicious subspace. In such fashion, the processing logic can convey information to the client computing device indicating that an entity is malicious while eliminating the exchange of private information.

Alternatively, at operation 237, the processing logic can provide information to client computing devices indicating that an identifying code is associated with a malicious subspace. More specifically, assume that subspace classification information is generated that identifies a particular subspace as being a malicious subspace. Rather than waiting for a request for identification of the identifying code from a client computing device, the processing logic can provide information to each client computing device indicating that the identifying code for that subspace is associated with a malicious subspace.

FIG. 2B is a flow diagram of an example method 200B for providing identifying codes known to be associated with malicious actors to client computing devices, in accordance with some implementations of the present disclosure. The method 200B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200B is performed by the cybersecurity module 108 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 240, the processing logic can obtain additional entity detection information from the client computing devices. The additional entity detection information can include information indicating whether an entity detected at the client computing device is malicious, and information that associates the entity with a particular subspace, as described with regards to operation 215 of FIG. 2A.

At operation 245, the processing logic can aggregate the additional entity detection information to obtain additional aggregated threat information as described with regards to operation 220 of FIG. 2A.

At operation 250, the processing logic can determine whether the additional aggregated threat information causes an update to a subspace. More specifically, the processing logic can determine whether the additional aggregated threat information, in conjunction with the aggregated threat information, is sufficient to:
(a) identify a previously unidentified subspace as being either a malicious subspace or a non-malicious subspace, or
(b) modify subspace classification information to change a subspace from being identified as being a malicious subspace to being identified as a non-malicious subspace (or vice-versa).

If the additional aggregated threat information is insufficient to identify a previously unidentified subspace and/or to modify subspace classification information, the processing logic can perform operation 240 to further aggregate the additional entity detection information. Otherwise, the processing logic can perform operation 255.

At operation 255, the processing logic can determine whether a particular subspace has previously been identified as being a malicious or non-malicious subspace. In other words, the processing logic can determine if subspace classification information has been generated for a particular subspace. \

If subspace classification information has not been previously generated for a particular subspace, the processing logic can perform operation 260. At operation 260, the processing logic can generate subspace classification information for the subspace based on the additional aggregated threat information in conjunction with the aggregated threat information.

Alternatively, if subspace classification information has been previously generated for a particular subspace, the processing logic can perform operation 265. At operation 265, the processing logic can modify the subspace classification information generated for the subspace based on the additional aggregated threat information in conjunction with the aggregated threat information.

For example, turning to FIG. 3, assume that the aggregated threat information aggregated at operation 220 of FIG. 2A indicates 7 malicious entities and 12 total entities associated with the subspace 310B. Further assume that the additional aggregated threat information indicates 0 additional malicious entities and 15 additional entities for a total of 7 malicious entities and 27 total entities. If subspace classification information was not previously generated for the subspace 310B, the additional aggregated threat information, in conjunction with the aggregated threat information, can be sufficient to identify the subspace 310B as being a non-malicious subspace. If subspace classification information that identifies the subspace 310B as being a malicious subspace was previously generated, the additional aggregated threat information, in conjunction with the aggregated threat information, can be sufficient to modify the subspace classification information. In this instance, the subspace classification information can be modified to remove information identifying the subspace 310B as being a malicious subspace. Additionally, in some implementations, the subspace classification information can be modified to add information identifying the subspace 310B as being a non-malicious subspace.

At operation 270, the processing logic can communicate an update to client computing devices as described with regards to operation 237 of FIG. 2A.

FIG. 4 is a block diagram of an example computing system that optimizes a shared embedding space for detection of malicious entities according to some implementations of the present disclosure. Computing system 400 can be any type or manner of computing system that provides cybersecurity services within a computing environment. For example, the computing system 400 can be a virtualized or hardware-based compute node within the computing environment, a collection of processes or virtualized instances executed in a cloud computing environment, a distributed set of physical and/or virtualized computing devices, etc.

The computing system 400 can be a system that provides cybersecurity services and/or implements cybersecurity functions within a computing environment, such as the computing system 102 within the computing environment 100 of FIG. 1. To do so, the computing system 400 can include a cybersecurity module 402. The cybersecurity module 402 can be any manner of software and/or hardware resources sufficient to provide cybersecurity services and/or implement cybersecurity functions.

The cybersecurity module 402 can include a machine-learned embedding model 404. The machine-learned embedding model 404 can be a model trained to generate embeddings for particular types of entities. For example, the machine-learned embedding model 404 can be an embedding model that is trained to generate embeddings of emails. For another example, the machine-learned embedding model 404 can be an embedding model trained to generate embeddings of behavioral patterns of actors (e.g., timestamped login requests, known IP addresses, etc.). In some implementations, the machine-learned embedding model 404 can be a model trained to generate embeddings from multimodal inputs. For example, the machine-learned embedding model 404 can be a model trained to process both an email and the behavioral patterns of an actor who sent the email to generate an embedding.

In some implementations, the machine-learned embedding model 404 can be trained by the cybersecurity module 402 and provided to client computing devices for utilization in generating embeddings locally. In this manner, client computing devices can generate embeddings to determine identifying codes for locally detected entities. Alternatively, in some implementations, the machine-learned embedding model 404 can be trained and then provided to the cybersecurity module 402.

The cybersecurity module 402 can include an embedding space 406. The embedding space 406 can be a lower-dimensional space to which embeddings can be mapped. For example, if the machine-learned embedding model 404 is trained to generate embeddings of emails, the embedding space 406 can be an embedding space to which embeddings of emails are mapped. The embedding space 406 can be partitioned into subspaces 408 as described with regards to operation 205 of FIG. 2A.

The cybersecurity module 402 can include subspace classification information 410. The subspace classification information 410 can associate subspaces 408 with particular identifying codes. To follow the illustrated example, the subspace classification information 410 can associate one subspace with the identifying code “00” and another subspace with the identifying code “1011.”

Additionally, the subspace classification information 410 can identify a particular subspace as being malicious, non-malicious, or not yet identified as being either. To follow the depicted example, the subspace classification information 410 can identify the subspace associated with code “01” as being non-malicious (e.g., a value of “0”), the subspace associated with code “1” as being malicious (e.g., a value of “1”), and the subspace associated with code “00” as not yet being identified as either malicious or non-malicious (e.g., a value of “TBD”).

The cybersecurity module 402 can include information processing module 412. The information processing module 412 can be a module that processes entity detection information 414. The entity detection information 414 can be received from client computing devices as described with regards to operation 215.

In some implementations, the information processing module 412 can include an information noiser 416. In some implementations, the information noiser 416 can apply noise to entity detection information 414. For example, assume that the entity detection information 414 indicates that an entity is malicious. The information noiser 416 can add noise to the entity detection information by modifying the entity detection information 414 to indicate that the entity is non-malicious. Alternatively, the information noiser 416 can add noise by modifying the identifying code included in the entity detection information 414. In some implementations, the information processing module 412 can mix entity detection information 414, and then add noise to the mixed entity detection information with the information noiser 416.

The information processing module 412 can include information aggregator 418. The information aggregator 418 can aggregate multiple sets of entity detection information 414 received from client computing devices to obtain aggregated threat information 420. The aggregated threat information 420 can indicate a number of malicious entities and a total number of entities associated with some (or all) of the subspaces 408.

The cybersecurity module 402 can include an embedding space partitioning module 422. The embedding space partitioning module 422 can perform various embedding space partitioning processes, such as LSH-Forest. To do so, the embedding space partitioning module 422 can include a random vector generator 424. The random vector generator 424 can generate randomized vectors 426 for use as hyperplanes to partition the embedding space 406. The random vector generator 424 can generate the randomized vectors 426 based on RNG seed(s) 428.

The cybersecurity module 402 can include a communication module 430. The communication module 430 can exchange information with client computing devices within the computing environment. For example, the communication module 430 can transmit RNG seed(s) 428 to client computing devices so that the randomized vectors 426 can be generated locally at the client computing devices.

In some implementations, the communication module 430 can include a homomorphic encryption handler 432. Homomorphic encryption is a form of encryption that allows data to be utilized without first being decrypting, which facilitates exchanging information between the communication module 430 and the client computing devices via private set membership information exchange. Private set information exchange is a cryptographic technique used to determine the intersection between two encrypted sets of data.

For example, a client computing device can generate a hash from an identifying code and provide the hash to the homomorphic encryption handler 432. The homomorphic encryption handler 432 can generate hashes from each of the identifying codes using the same hashing protocol as the client computing device. If the hash received from the client computing device matches a hash for an identifying code of a subspace, and the subspace is identified as being a malicious subspace, the homomorphic encryption handler 432 can provide information to the client computing device indicating that the hash provided by the client computing device is a member of the private set (e.g., the “private set” of malicious subspaces). In such fashion, the homomorphic encryption handler 432 can further obfuscate information exchanged between the cybersecurity module 402 and client computing devices to be utilized to reduce the likelihood of malicious actors gaining access to sensitive information.

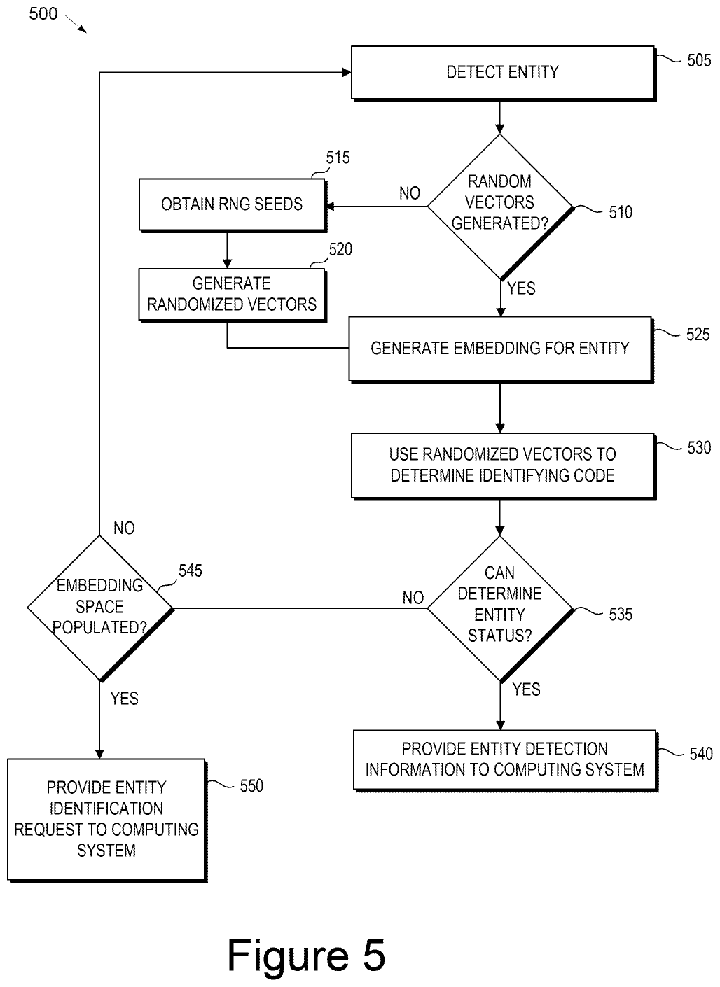

FIG. 5 is a flow diagram of an example method 500 for populating a shared embedding space for detection of malicious entities in a federated, privacy-preserving manner, in accordance with some implementations of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the threat detection module 105 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 505, processing logic can detect an entity. As described previously, an entity can refer to a specific actor (e.g., a human, an automated program, etc.), information sent by an actor (e.g., an email, code package, etc.), action(s) taken actor(s), and/or the behavior of actor(s). As such, an entity can be “detected” in a variety of ways, depending on the type of entity detected. For example, an email can be detected if it is received and decrypted by the processing logic. For another example, an actor, such as a specific machine, can be detected based on the machine identifier associated with information received from the actor (e.g., a Media Access Control (MAC) address, etc.). For yet another example, an action taken by an actor, such as sending a request intended to cause a DDOS attack, can be detected upon receipt of the request.

At operation 510, the processing logic can determine whether randomized vectors have been generated. If randomized vectors have not been generated previously, the processing logic can perform operation 515. Otherwise, the processing logic can perform operation 525.

At operation 515, the processing logic can obtain RNG seeds from a computing system. The computing system can be a system that implements cybersecurity services and/or functions within a computing environment in which the processing logic operates. The RNG seeds can be seeds used previously to generate randomized vectors for use as random hyperplanes when partitioning an embedding space implemented at the computing system in a deterministic fashion. As the randomized vectors were deterministically generated at the computing system for use as random hyperplanes, the same randomized vectors can be generated at the client computing device in the same deterministic manner based on the RNG seeds.

At operation 520, the processing logic can generate the randomized vectors based on the RNG seeds in the same deterministic manner used by the computing system that provided the RNG seeds.

At operation 525, the processing logic can generate an embedding for the detected entity. The embedding can be generated by processing data descriptive of the entity, data associated with the entity, and/or the entity itself (if the entity is data) with a machine-learned embedding model. For example, if the entity is an email, inputs to the machine-learned embedding model can include the textual content of the email, attachments included in the email, the sender's email address, the time at which the email was sent, an IP address associated with the sender, a local time associated with the IP address of the sender, etc. For another example, if the entity is an actor, the inputs to the machine-learned embedding model can include data descriptive of user accounts created by the actor, logs descriptive of actions performed by the actor, identifying information associated with the actor (e.g., IP address(es), MAC address(es), etc.), etc.

The machine-learned embedding model can be any type or manner of model trained to generate an embedding of a particular type of entity, or for multiple types of entities. As a non-limiting example, the machine-learned embedding model can be a lightweight neural network trained by the computing system via distillation training. In some implementations, the computing system can provide model update information to update parameter values for the machine-learned embedding model. Additionally, or alternatively, in some implementations, the machine-learned embedding model can include multiple machine-learned embedding models that are each trained to generate embeddings for a particular type of entity.

At operation 530, the processing logic can use the randomized vectors to determine an identifying code for the entity. As described with regards to the embedding space partitioning module 422 of FIG. 4, the randomized vectors can be the same vectors used as hyperplanes to partition the embedding space 406 of FIG. 4 via a process such as LSH-Forest. However, given access to the randomized vectors, embedding space partitioning processes such as LSH-Forest enable local determination of the same identifying codes established during partitioning of the embedding space.

More specifically, identifying codes, such as hash codes, can be established for each subspace of an embedding space when partitioned using a process such as LSH-Forest. This partitioning is accomplished using randomized vectors as random hyperplanes. However, given access to the same randomized vectors used to partition an embedding space, an accurate identifying label can be locally determined for a detected entity without knowledge of the subspaces of the embedding space, or the identifying codes already associated with the subspaces. The identifying label can be locally determined by performing a dot product multiplication process between the randomized vectors and the embedding determined for the entity. As such, without prior knowledge of a particular identifying code and the subspace it is associated with, the processing logic can still utilize the randomized vectors to accurately determine and assign that particular identifying code to an entity.

At operation 535, the processing logic can attempt to determine an entity status. In particular, the processing logic can attempt to determine whether the entity is malicious. The processing logic can determine whether the entity is malicious using any manner of conventional malicious entity detection technique. For example, the processing logic can process information processed to generate the embedding for the entity at operation 525 with a machine-learned entity analysis model trained to determine whether an entity is malicious. For another example, the processing logic can utilize heuristic threshold values to determine whether an entity is malicious, such as a quantity of access attempted performed within a period of time, or a number of data packets received in a period of time. However, in some instances, the processing logic can be unable to determine whether an entity is malicious. For example, if access logs are not available for an actor, the processing logic may lack sufficient information to determine whether an entity is malicious.

If the processing logic is able to determine whether the entity is malicious, the processing logic can perform operation 540. However, if the processing logic is unable to determine whether the entity is malicious, the processing logic can perform operation 545.

At operation 540, the processing logic can provide entity detection information to the computing system. The entity detection information can include the (a) information that indicates whether an entity is malicious, and (b) the information that associates the entity with a particular subspace as described with regards to operation 215 of FIG. 2A.

At operation 545, the processing logic can determine whether the embedding space implemented on the computing system is populated. Specifically, the processing logic can perform operations 505-540 to contribute to population of the embedding space over a number of iterations. In some implementations, after obtaining a sufficient quantity of entity detection information, the computing system can indicate that the embedding space is sufficiently populated to be utilized for identification of malicious entities. If such an indication has been received, the processing logic can perform operation 550. If such an indication has not been received, the processing logic can refrain from providing information to the computing system and can wait to detect another entity.

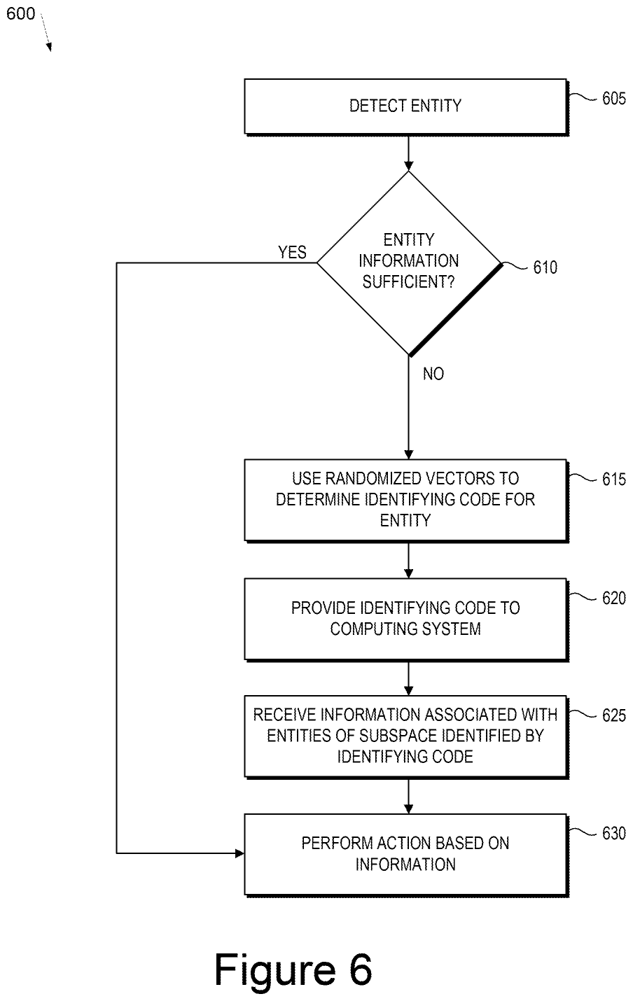

At operation 550, the processing logic can provide an entity identification request to the computing system. The entity identification request can include the identifying code determined at operation 530. In response, the computing system can provide information indicating whether the subspace associated with the identifying code is a malicious subspace. Entity identification request handling will be discussed in greater detail with regards to FIG. 6.

Alternatively, in some implementations, rather than determining whether the embedding space is sufficiently populated at operation 545, the processing logic can instead proceed directly from operation 535 to operation 550. If the subspace identified by the identifying code is insufficiently populated to identify malicious entities, the computing system can indicate that the subspace is insufficiently populated as a response to the request.

FIG. 6 is a flow diagram of an example method 600 for requesting identification of an entity from a computing system that implements an embedding space that has been populated in a federated, privacy-preserving manner, in accordance with some implementations of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the threat detection module 105 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 605, the processing logic can detect an entity. In some implementations, the entity can be cybersecurity-related as described with regards to operation 505 of FIG. 5. Alternatively, in some implementations, the entity can be content (e.g., a movie, book, television show, videogame, article, etc.), a subject (e.g., sports, current events, etc.), location (e.g., vacation destination, landmark, etc.), or some other manner of entity. For example, the entity can be a content currently selected by a user of a streaming service.

At operation 610, the processing logic can determine whether information associated with the entity is sufficient. In some implementations, processing logic can determine whether information associated with the entity is sufficient the to determine whether the entity is malicious, as described with regards to operation 535 of FIG. 5. Alternatively, in some implementations, the processing logic can determine whether the information associated with the entity is sufficient to perform some other action, such as providing content recommendations, answering a query, suggesting a destination, etc. For example, the processing logic can determine whether the information associated with content selected by a user is sufficient to generate recommendations for content similar to the selected content.

If the information is sufficient, the processing logic can perform operation 630. If the information is insufficient, the processing logic can perform operation 615.

At operation 615, the processing logic can use randomized vectors to determine an identifying code for the entity as described with regards to operation 530 of FIG. 5.

At operation 620, the processing logic can provide the identifying code to the computing system. For example, the processing logic can provide an entity identification request to the computing system that includes the identifying code. For another example, the processing logic can generate a hash of the identifying code and provide the hash to the computing system to utilize private set membership encryption as described with regards to the homomorphic encryption handler 432 of FIG. 4.

At operation 625, the processing logic can receive information associated with entities of the subspace identified by the identifying code. For example, if the entity is a cybersecurity-related entity, the received information can indicate whether the entity is malicious. For another example, if the entity is content selected by a user, the received information can describe other content items associated with the same subspace as the entity. For yet another example, if the entity is a destination, the received information can describe other destinations associated with the same subspace as the entity.

At operation 630, the processing logic can perform an action based on the received information. In some implementations, if the entity is a cybersecurity-related entity, the processing logic can perform a corrective action. For example, if the entity is data, or a file, the processing logic can assign the entity to a location associated with malicious data within a file system, or can perform a process to delete the data. For another example, the processing logic can generate an alert element indicating that the entity is malicious within an interface of an application. For another example, the processing logic can provide reporting information indicating that the entity is malicious to a computing device or system.

Alternatively, if the entity is not a cybersecurity-related entity, the processing logic can perform other actions. For example, if the entity is an item of content, the processing logic can provide content recommendations to a user. For another example, if the entity is a destination, the processing logic can suggest similar destinations to a user.

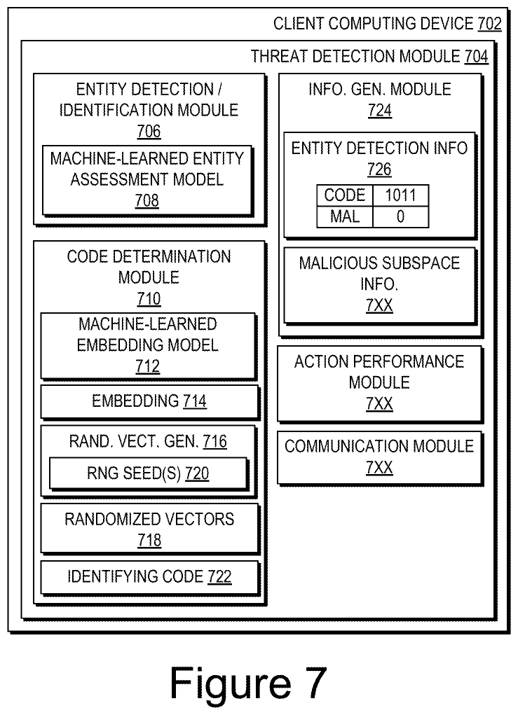

FIG. 7 is a block diagram of an example client computing device that populates a shared embedding space for detection of malicious entities according to some implementations of the present disclosure. Specifically, the client computing device 702 can be any type of manner of computing device, computing system, compute node, etc. that is served by a computing system within a computing environment. For example, the client computing device 702 can be a personal computing device, such as a laptop, desktop, smartphone, wearable device, peripheral device (e.g., Augmented Reality/Virtual Reality (AR/VR) device), etc. For another example, the client computing device can be a compute node (e.g., a virtualized compute instance, a collection of microservices, etc.) within a computing environment. For another example, the client computing device can be an Internet-of-Things (IoT) device, such as a parking meter, water meter, thermostat, etc.).

The client computing device 702 can include a threat detection module 704. The threat detection module 704 can be a module that locally implements cybersecurity processes/functions to protect the client computing device 702 from malicious entities. To do so, the threat detection module 704 can perform a variety of functions, such as detecting spam emails, maintaining firewall protections, scanning incoming information for viruses, handling requests, etc.

In particular, the threat detection module 704 can include an entity detection/identification module 706. The entity detection/identification module 706 can detect and identify entities, and can do so in different ways depending on the type of entity. For example, the entity detection/identification module 706 can include a machine-learned entity assessment model 708. The machine-learned entity assessment model 708 can be a model trained to process information associated with an entity to determine whether the entity is malicious.

The threat detection module 704 can include a code determination module 710. The code determination module 710 can determine an identifying code for an entity detected by the entity detection/identification module 706. To do so, the code determination module 710 can include a machine-learned embedding model 712 and a random vector generator 716. The machine-learned embedding model 712 can be trained to generate an embedding 714 for an entity detected by the entity detection/identification module 706. The random vector generator 716 can deterministically generate randomized vectors 718 based on RNG seeds 720 received from the computing system that implements the embedding space. The code determination module 710 can determine identifying code 722 for the entity by performing a dot multiplication process between the randomized vectors 718 and the embedding 714.

The threat detection module 704 can include information generation module 724, which can generate entity detection information 726. The entity detection information 726 can include the identifying code 722 generated by the code determination module 710. The entity detection information 726 can also include an indication of whether the entity is malicious, as determined by the entity detection/identification module 706.

The information generation module 724 can also maintain malicious subspace information 728. The malicious subspace information 728 can be received from a computing system, and can store identifying codes associated with malicious subspaces. For example, assume that the computing system implementing the embedding space identifies a particular subspace as being a malicious subspace. The computing system can provide malicious subspace information 728 to the client computing device 702 that includes the identifying code associated with that particular subspace. In this manner, if an embedding generated for a subsequently detected entity is the same as the identifying code stored in the malicious subspace information 728, the threat detection module 704 can determine that the entity is malicious based on the malicious subspace information 728, rather than by providing a request to the computing system.

The threat detection module 704 can include an action performance module 730. The action performance module 730 can perform corrective actions if an entity is identified as being a malicious entity as described with regards to operation 630 of FIG. 6.

The threat detection module 704 can include a communication module 732. The communication module 732 can facilitate the exchange of information between the client computing device 702 and a computing system as described with regards to the communication module 430 of FIG. 4.

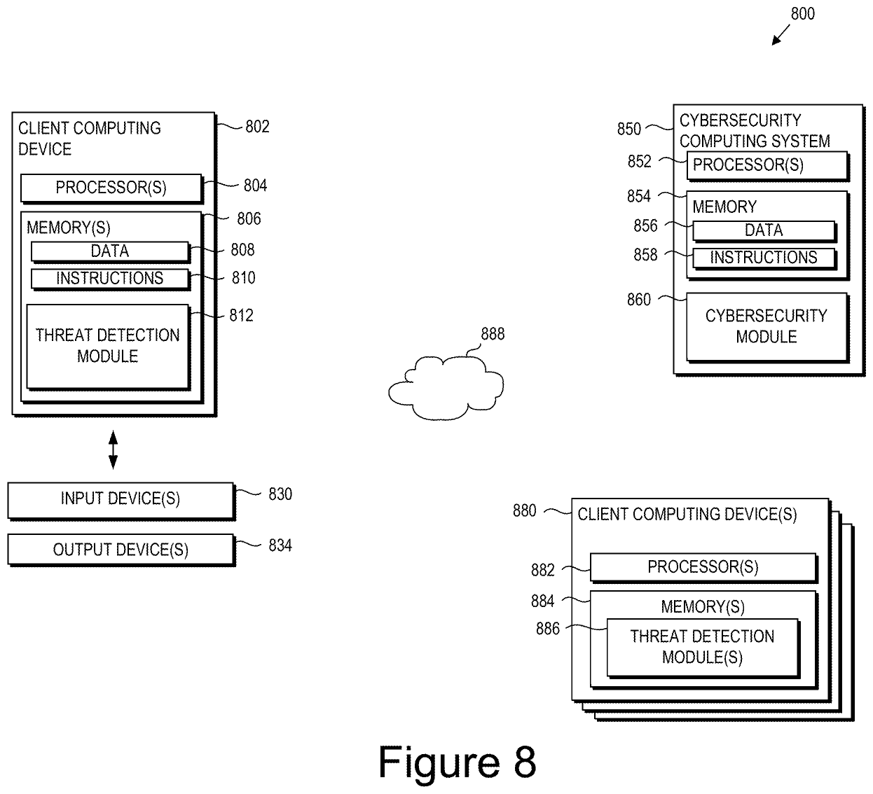

FIG. 8 depicts a block diagram of an example computing environment 800 suitable for implementing examples according to some implementations of the present disclosure. The computing environment 800 includes a client computing device 802, a cybersecurity computing system 850, and, in some implementations, other client computing device(s) 880.

The client computing device 802 can be any type or manner of computing device that is provided cybersecurity services or functions by a cybersecurity computing system, such as, for example, a personal computing device (e.g., laptop or desktop), a mobile computing device (e.g., smartphone or tablet), a gaming console or controller, a wearable computing device (e.g., an virtual/augmented reality device, etc.), an embedded computing device, a broadcasting computing device (e.g., a webcam, etc.), a virtualized computing device, an IoT device, a compute node, etc.

The client computing device 802 includes processor(s) 804 and memory(s) 806. The processor(s) 804 can be any suitable processing device (e.g., a processor core, a microprocessor, an ASIC, an FPGA, a controller, a microcontroller, etc.) and can be one processor or processors that are operatively connected. The memory 806 can include non-transitory computer-readable storage media(s), such as RAM, ROM, EEPROM, EPROM, flash memory devices, magnetic disks, etc., and combinations thereof. The memory 806 can store data 808 and instructions 810 which are executed by the processor 804 to cause the client computing device 802 to perform operations.

In particular, the memory 806 of the client computing device 802 can include the threat detection module 812. The threat detection module 812 can provide various cybersecurity functions to locally protect the client computing device 802 from malicious entities. One cybersecurity function provided by the threat detection module 812 is the local detection and identification of entities. For example, the client computing device 802 can utilize the threat detection module 814 to detect entities. Once detected, the threat detection module 812 can attempt to identify the entity. If an entity is successfully identified, the threat detection module 812 can generate entity detection information to populate an embedding space. If the entity is not successfully identified, the threat detection module 812 can provide an entity identification request to the cybersecurity computing system 850.

To detect and identify entities, the threat detection module 812 can include a variety of modules, submodules, information, machine-learned model(s), and/or resources, as described in greater detail with regards to the threat detection module 704 of FIG. 7. For example, the threat detection module 812 can include a machine-learned threat assessment model trained to detect and identify threats.

The client computing device 802 can also include input device(s) 830 that receive inputs from a user, or otherwise capture data associated with a user. For example, the input device(s) 830 can include a touch-sensitive device (e.g., a touch-sensitive display screen or a touch pad) that is sensitive to the touch of a client input object (e.g., a finger or a stylus). The touch-sensitive device can serve to implement a virtual keyboard. Other example user input components include a microphone, a traditional keyboard, or other means by which a client can provide user input.

In some implementations, the input device(s) 830 can include sensor devices configured to capture sensor data indicative of movements of a client associated with the cybersecurity computing system 850 (e.g., accelerometer(s), Global Positioning Satellite (GPS) sensor(s), gyroscope(s), infrared sensor(s), head tracking sensor(s) such as magnetic capture system(s), an omni-directional treadmill device, sensor(s) configured to track eye movements of the user, etc.).

In some implementations, the client computing device 802 can include, or be communicatively coupled to, output device(s) 834. Output device(s) 834 can be, or otherwise include, device(s) configured to output audio data, image data, video data, etc. For example, the output device(s) 834 can include a two-dimensional display device (e.g., a television, projector, smartphone display device, etc.). For another example, the output device(s) 834 can include display devices for an augmented reality device or virtual reality device.

The cybersecurity computing system 850 includes processor(s) 852 and a memory 854. The processor(s) 852 can be any suitable processing device (e.g., a processor core, a microprocessor, an ASIC, an FPGA, a controller, a microcontroller, etc.) and can be one processor or processors that are operatively connected. The memory 854 can include non-transitory computer-readable storage media(s), such as RAM, ROM, EEPROM, EPROM, flash memory devices, magnetic disks, etc., and combinations thereof. The memory 854 can store data 856 and instructions 858 which are executed by the processor 852 to cause the cybersecurity computing system 850 to perform operations.

In some implementations, the cybersecurity computing system 850 can be, or otherwise include, a virtual machine or containerized unit of software instructions executed within a virtualized cloud computing environment (e.g., a distributed, networked collection of processing devices), and can be instantiated on request. Additionally, or alternatively, in some implementations, the cybersecurity computing system 850 can be, or otherwise include, physical processing devices, such as processing nodes within a cloud computing network (e.g., nodes of physical hardware resources).

The cybersecurity computing system 850 can include a cybersecurity module 860. The cybersecurity module 860 can provide various cybersecurity functions/processes to client computing devices such as the client computing device 802. In particular, the cybersecurity module 860 can implement a partitioned embedding space to identify entities that cannot be locally identified by the client computing device 802. For example, if the client computing device 802 cannot identify an entity, the client computing device 802 can provide an entity identification request to the cybersecurity module 860 that includes an identifying code for the entity. If the identifying code is associated with a particular subspace of the embedding space, and the subspace is known to be a malicious subspace, the cybersecurity module 860 can indicate to the client computing device 802 that the entity is identified as being malicious.

To implement cybersecurity processes/functions, the cybersecurity module 860 can include a variety of modules, submodules, information, machine-learned model(s), and/or resources, as described in greater detail with regards to the cybersecurity module 402 of FIG. 4.

In some implementations, the cybersecurity computing system 850 includes, or is otherwise implemented by, server computing device(s). In instances in which the cybersecurity computing system 850 includes multiple server computing devices, such server computing devices can operate according to sequential computing architectures, parallel computing architectures, or some combination thereof.

In some implementations, the transmission and reception of data by cybersecurity computing system 850 can be accomplished via the network 899. For example, in some implementations, the client computing device 802 can generate entity detection information and can transmit the entity detection information to the cybersecurity computing system 850. The cybersecurity computing system 850 can receive the data via the network 899.

In some implementations, the cybersecurity computing system 850 can receive data from the client computing device(s) 802 and 880 according to various encryption scheme(s) (e.g., codec(s), lossy compression scheme(s), lossless compression scheme(s), etc.). For example, the client computing device 802 can encode information with a homomorphic encryption scheme, such as private set membership, and then transmit the encoded information to the cybersecurity computing system 850. Without needing to decode the information, the cybersecurity computing system 850 can utilize the encoded information to identify whether an associated entity is malicious.

The cybersecurity computing system 850 and the client computing device 802 can communicate with the client computing device(s) 880 via the network 899. The client computing device(s) 880 can be any type of computing device(s), such as, for example, a personal computing device (e.g., laptop or desktop), a mobile computing device (e.g., smartphone or tablet), a gaming console or controller, a wearable computing device (e.g., an virtual/augmented reality device, etc.), an embedded computing device, a broadcasting computing device (e.g., a webcam, etc.), or any other type of computing device.

The client computing device(s) 880 includes processor(s) 882 and a memory 884 as described with regards to the client computing device 802. Specifically, the client computing device(s) 880 can be the same, or similar, device(s) as the client computing device 802. For example, the client computing device(s) 880 can each include a threat detection module 886 that includes at least some portions of the threat detection module 812. For another example, the client computing device(s) 880 may include, or may be communicatively coupled to, the same type of input and output devices as described with regards to input device(s) 830 and output device(s) 834. Alternatively, in some implementations, the client computing device(s) 880 can be different devices than the client computing device 802, but can also contribute to population of the embedding space implemented by the cybersecurity computing system 850. For example, the client computing device 802 can be a laptop and the client computing device(s) 880 can be virtualized compute nodes that monitor for intrusion attempts in a network.

The network 899 can be any type of communications network, such as a local area network (e.g., intranet), wide area network (e.g., Internet), or some combination thereof and can include any number of wired or wireless links. In general, communication over the network 899 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

The following definitions provide a detailed description of various terms discussed throughout the subject specification. As such, it should be noted that any previous reference in the specification to the following terms should be understood in light of these definitions.

Cloud: as used herein, the term “cloud” or “cloud computing environment” generally refers to a network of interconnected computing devices (e.g., physical computing devices, virtualized computing devices, etc.) and associated storage media which interoperate to perform computational operations such as data storage, transfer, and/or processing. In some implementations, a cloud computing environment can be implemented and managed by an information technology (IT) service provider. The IT service provider can provide access to the cloud computing environment as a service to various users, who can in some circumstances be referred to as “cloud customers.”

Computing Environment: as used herein, the term “computing environment” generally refers to a collection of computing device(s) and system(s) that are directly or indirectly associated. Computing devices/systems can be considered “associated” if they exist within the same network, are owned by or associated with the same entity (e.g., a user, a business, etc.), are implemented by the same physical or virtual hardware, etc. For example, the computing environment of an internet service provider (ISP) can include every user device served by the ISP, compute nodes within the network of the ISP, computing devices implementing frontend or backend services for the ISP, IoT devices served by ISP, etc. For another example, the computing environment of a cloud computing provider can include the physical and virtualized hardware resources of the cloud computing provider, any compute instances implemented by the physical/virtualized hardware resources, external computing devices that communicate with the compute instances, etc.

Client computing device: as used herein, the term “client computing device” generally refers to any computing device, computing system, and/or collection of computing devices that is protected from malicious entities by a cybersecurity computing system within the same computing environment as the client computing device. A computing device can be protected by a cybersecurity computing system if the computing device is within the same computing environment as the cybersecurity computing system and the cybersecurity computing system monitors for external and/or internal threats.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, comprising:
for a plurality of iterations, obtaining, by a computing system comprising one or more processor devices, entity detection information from one or more client computing devices, wherein the entity detection information comprises:
(a) information that indicates whether an entity detected at the client computing device is malicious; and
(b) information that associates the entity with a particular subspace of a plurality of subspaces of an embedding space;
aggregating, by the computing system, the entity detection information received over the plurality of iterations to obtain aggregated threat information, wherein the aggregated threat information is descriptive of a number of malicious entities and a total number of entities detected for each subspace of the plurality of subspaces; and
based on the entity detection information, generating, by the computing system, subspace classification information that identifies a first subspace of the plurality of subspaces as being a malicious subspace associated with malicious entities.

2. The computer-implemented method of claim 1, wherein, prior to obtaining the entity detection information from the one or more client computing devices, the method comprises performing, by the computing system, a Locality Sensitive Hashing (LSH) process based on a plurality of randomized vectors, wherein performing the LSH process comprises:
partitioning, by the computing system, the embedding space into the plurality of subspaces; and
determining, by the computing system, a plurality of identifying codes that each identify a respective subspace of the plurality of subspaces of the embedding space.

3. The computer-implemented method of claim 2, wherein performing the LSH process further comprises:
providing, by the computing system, information indicative of the plurality of randomized vectors to the one or more client computing devices.

4. The computer-implemented method of claim 3, wherein, prior to performing the LSH process, the method comprises generating, by the computing system, the plurality of randomized vectors based on one or more Random Number Generation (RNG) seeds; and
wherein providing the information indicative of the plurality of randomized vectors to the one or more client computing devices comprises providing, by the computing system, the one or more RNG seeds to the one or more client computing devices.

5. The computer-implemented method of claim 4, wherein the information that associates the entity with the particular subspace comprises an identifying code for the particular subspace generated as a dot product of the plurality of randomized vectors and an embedding of the entity.

6. The computer-implemented method of claim 3, wherein the information that associates the entity with the particular subspace of the plurality of subspaces of the embedding space comprises information indicative of a particular identifying code of the plurality of identifying codes that is associated with the particular subspace.

7. The computer-implemented method of claim 6, wherein the method further comprises:
broadcasting, by the computing system to the one or more computing devices, information that identifies a first identifying code of the plurality of identifying codes as being associated with malicious entities, wherein the first identifying code is associated with the first subspace.

8. The computer-implemented method of claim 7, wherein the method further comprises:
for one or more additional iterations, obtaining, by the computing system, additional entity detection information from the one or more client computing devices, wherein the additional entity detection information comprises:
(a) information that indicates whether an additional entity detected at the client computing device is malicious; and
(b) information that associates the additional entity with a particular subspace of a plurality of subspaces of an embedding space; and
aggregating, by the computing system, the additional entity detection information received over the one or more additional iterations to obtain additional aggregated threat information.

9. The computer-implemented method of claim 8, wherein the method further comprises:
based on the additional aggregated threat information, identifying, by the computing system, a second subspace of the plurality of subspaces as being a malicious subspace associated with malicious entities;
generating, by the computing system, additional subspace classification information to identify the second subspace as being a malicious subspace associated with malicious entities; and
providing, by the computing system to the one or more client computing devices, information that identifies a second identifying code of the plurality of identifying codes as being associated with malicious entities, wherein the second identifying code is associated with the second subspace.

10. The computer-implemented method of claim 8, wherein the method further comprises:
based on the additional aggregated threat information, modifying, by the computing system, the subspace classification information to identify the first subspace of the plurality of subspaces as being a non-malicious subspace associated with non-malicious entities; and
broadcasting, by the computing system to the one or more client computing devices, information that identifies the first identifying code of the plurality of identifying codes as being associated with non-malicious entities, wherein the first identifying code is associated with the first subspace.

11. The computer-implemented method of claim 6, wherein the method further comprises:
receiving, by the computing system from a client computing device of the one or more client computing devices, a request to identify whether an identifying code for an entity detected at the client computing device is associated with a malicious subspace;
determining, by the computing system, that the identifying code is associated with a malicious subspace; and
providing, by the computing system to the client computing device, information indicating that the identifying code is associated with a malicious subspace.

12. The computer-implemented method of claim 11, wherein, prior to receiving the request to identify whether the identifying code for the entity detected at the client computing device is associated with a malicious subspace, the method comprises:
establishing, by the computing system, a homomorphic encryption protocol for communication between the computing system and the client computing device.

13. The computer-implemented method of claim 1, wherein the entity detected by the client computing device comprises:
communication information;
behavioral information;
a user account; or
a computing device.

14. The computer-implemented method of claim 1, wherein, prior to aggregating the entity detection information received over the plurality of iterations, the method comprises:
mixing, by the computing system, at least some of the entity detection information received over the plurality of iterations to obtain mixed entity detection information; and
adding, by the computing system, noise to the mixed entity detection information.

15. A client computing device, comprising:
one or more processors; and
one or more non-transitory computer-readable media that collectively store a first set of instructions that, when executed by the one or more processors, cause the client computing device to perform operations, the operations comprising:
for one or more iterations:
detecting an entity;
determining whether the entity is malicious;
using a plurality of randomized vectors to determine an identifying code for the entity, wherein the plurality of randomized vectors are for performing a Locality Sensitive Hashing (LSH) process that partitions an embedding space of a computing system into a plurality of subspaces with a structure that is unknown to the client computing device, and wherein the identifying code is one of a plurality of identifying codes respectively associated with the plurality of subspaces; and
providing, to the computing system, entity detection information, wherein the entity detection information comprises:
(a) information that indicates whether the entity is malicious; and
(b) information indicative of the identifying code for the entity.

16. The client computing device of claim 15, wherein using the plurality of randomized vectors to determine the identifying code for the entity comprises:
receiving, from the computing system, Random Number Generation (RNG) seeds utilized to generate the plurality of randomized vectors at the computing system; and
generating the plurality of randomized vectors based on the RNG seeds.

17. The client computing device of claim 16, wherein using the plurality of randomized vectors to determine the identifying code for the entity further comprises:
processing information associated with the entity with a machine-learned embedding model to obtain an entity embedding; and
determining the identifying code for the entity based on the plurality of randomized vectors and the embedding.

18. The client computing device of claim 17, wherein the operations further comprise:
detecting an additional entity;
determining that information associated with the additional entity is insufficient for determining whether the entity is malicious;
using the plurality of randomized vectors to determine an additional identifying code for the additional entity;
providing, to the computing system, a request to identify whether the additional identifying code for the additional entity is associated with a malicious subspace; and
responsive to providing the request, receiving, from the computing system, information indicating that the additional entity is associated with a malicious subspace.

19. The client computing device of claim 18, wherein the operations further comprise:
performing a corrective action based on the information indicating that the additional entity is associated with a malicious subspace.

20. The client computing device of claim 19, wherein performing the corrective action comprises:
assigning the additional entity to a location associated with malicious entities within a file system of the client computing device;
generating, within an interface of an application executed by the client computing device, an alert element indicating that the entity is malicious;
blocking transmission of data from the entity;
providing reporting information indicating that the entity is malicious to a computing device other than the computing system; or
deleting data received from the entity.

21. The client computing device of claim 20, wherein determining whether the entity is malicious comprises processing information associated with the entity with a machine-learned threat assessment model.

22. The client computing device of claim 21, wherein the operations further comprise:
training the machine-learned threat assessment model based on the information indicating that the additional entity is associated with the malicious subspace.

23. One or more non-transitory computer-readable media that collectively store a first set of instructions that, when executed by one or more processors of a client computing device, cause the client computing device to perform operations, the operations comprising:
using a plurality of randomized vectors to determine an identifying code for an entity, wherein the plurality of randomized vectors are for performing a Locality Sensitive Hashing (LSH) process that partitions an embedding space of a computing system into a plurality of subspaces, and wherein the identifying code is one of a plurality of identifying codes that each identify a respective subspace of the plurality of subspaces;
providing, to the computing system, the identifying code to the computing system;
responsive to providing the identifying code, receiving, from the computing system, information associated with entities of the subspace identified by the identifying code; and
performing an action based on the information associated with the entities of the subspace identified by the identifying code.

24. A cybersecurity computing system, comprising:
one or more processors; and
a memory, comprising:
an embedding space, wherein the embedding space is partitioned into a plurality of subspaces based on a plurality of randomized vectors; and
one or more non-transitory computer-readable media that collectively store a first set of instructions that, when executed by the one or more processors, cause the cybersecurity computing system to perform operations, the operations comprising:
receiving an entity identification request from a client computing device that comprises an identifying code, wherein:
(a) the identifying code is determined based on the plurality of randomized vectors for an entity detected locally at the client computing device; and
(b) the identifying code is one of a plurality of identifying codes respectively associated with a plurality of subspaces of an embedding space;
determining that the subspace associated with the identifying code is a malicious subspace associated with malicious entities; and
providing information to the client computing device indicating that the entity is a malicious entity.

25. A client computing device, comprising:
one or more processors; and
a memory, comprising:
a machine-learned embedding model, wherein the machine-learned embedding model is trained to process information associated with an entity to generate an embedding for the entity; and
one or more non-transitory computer-readable media that collectively store a first set of instructions that, when executed by the one or more processors, cause the client computing device to perform operations, the operations comprising:
detecting an entity;
processing information associated with the entity with the machine-learned embedding model to generate an entity embedding;
based on a plurality of randomized vectors and the entity embedding, determining an identifying code for the entity, wherein the identifying code is one of a plurality of identifying codes respectively associated with a plurality of subspaces of an embedding space implemented by a computing system, and wherein the plurality of randomized vectors are the same vectors used to partition the embedding space into the plurality of subspaces;
providing, to the computing system, an entity identification request comprising the identifying code; and
responsive to providing the entity identification request, receiving, from the computing system, information indicating that the entity is malicious.
